(19) United States
(12) Patent Application Publication
(10) Pub. No.: US 2023/0267350 A1
(43) Pub. Date: Aug. 24, 2023

(54) INFERENCE APPARATUS, INFERENCE METHOD, AND COMPUTER-READABLE RECORDING MEDIUM

(71) Applicant: NEC Corporation, Minato-ku, Tokyo (JP)

(72) Inventor: Daichi KIMURA, Tokyo (JP)

(73) Assignee: NEC Corporation, Minato-ku, Tokyo (JP)

(21) Appl. No.: 18/010,095

(22) PCT Filed: Jun. 17, 2020
(86) PCT No.: PCT/JP2020/023769

§ 371 Date: Dec. 13, 2022

(51) Int. Cl. G06N 5/04; G06N 5/02

(52) U.S. Cl. CPC G06N 5/041; G06N 5/02

(57) ABSTRACT

An inference apparatus includes: a generation unit that generates, based on first observation literals included in a first observation logical formula that represents an observation fact using a logical formula, a second observation logical formula including second observation literals expressing a numerical relationship of the first observation literals, and adds the second observation logical formula to the first observation logical formula: and an abduction unit that executes abduction by applying inference knowledge including a plurality of rules that are represented by logical formulas to the first observation logical formula and the second observation logical formula.

### TECHNICAL FIELD

The invention relates to an inference apparatus and an inference method for performing inference for deriving a hypothesis with respect to observed events, and further relates to a computer-readable recording medium having recorded thereon a program for realizing the apparatus and method.

### BACKGROUND ART

In the cyber security, when a certain event is observed in a system of an organization, for example, whether the observed event has been caused by a cyber-attack needs to be determined. A method of applying abduction is promising as a method for realizing such determination.

Abduction is inference for deriving a best hypothesis with respect to observed events using inference knowledge (plurality of rules) given by logical formulas and an event that has been observed (observed event). A case where abduction is applied to the above-described determination as to whether or not a cyber-attack has been executed on a system will be described as an example. Whether or not there was a cyber-attack is determined by deriving a hypothesis using rules prepared in advance for the system and the observed event.

Moreover, abduction includes weighted abduction disclosed in Non-Patent Document 1 for specifying a best hypothesis from a plurality of hypothesis candidates. In the weighted abduction, weights are assigned to rules, and costs are assigned to observed events. Next, in the weighted abduction, hypothesis candidates are generated by performing a backward reasoning operation with respect to the weighted rules and the observed events with cost. Also, in the weighted abduction, a cost is calculated for each hypothesis candidate by performing a unification operation, and a hypothesis is specified from the generated hypothesis candidates based on the calculated costs. Note that, with respect to the hypothesis candidates, the costs indicate that the smaller the cost is, the hypothesis is better. The hypothesis candidate with a minimum cost is also referred to as a solution hypothesis.

### LIST OF RELATED ART DOCUMENTS

### Non-Patent Document

Non-Patent Document 1: J. R. Hobbs, M. Stickel, P. Martin, and D. Edwards, “Interpretation as abduction”, Artificial Intelligence, Vol. 63, pp. 69-142, 1993.

### SUMMARY

### Technical Problems

However, logical formulas are used in abduction, and therefore a numerical relationship cannot be handled. For example, numerical relationships are desired to be reflected on abduction in cases such as a case where, when a plurality of evidences (observed events) are obtained, it is desired that the closer the times at which evidences are obtained, the evidences are regarded to be more related to each other, and in a case where, when evidences of the same type are obtained, it is desired to adopt an evidence that is observed earlier. However, the numerical relationship is difficult to be represented by a logical formula.

An example object of the invention, as one aspect, is to provide an inference apparatus, an inference method and a computer-readable recording medium, with which a numerical relationship can be reflected on abduction.

### Solution to the Problems

In order to achieve the example object described above, an inference apparatus according to an example aspect includes:

a generation unit that generates, based on first observation literals included in a first observation logical formula that represents an observation fact using a logical formula, a second observation logical formula including second observation literals expressing a numerical relationship of the first observation literals, and adds the second observation logical formula to the first observation logical formula: and

an abduction unit that executes abduction by applying inference knowledge including a plurality of rules that are represented by logical formulas to the first observation logical formula and the second observation logical formula.

Also, in order to achieve the example object described above, an inference method according to an example aspect includes:

a generation step of generating, based on first observation literals included in a first observation logical formula that represents an observation fact using a logical formula, a second observation logical formula including second observation literals expressing a numerical relationship of the first observation literals, and adding the second observation logical formula to the first observation logical formula: and

an abduction step of executing abduction by applying inference knowledge including a plurality of rules that are represented by logical formulas to the first observation logical formula and the second observation logical formula.

Furthermore, in order to achieve the example object described above, a computer-readable recording medium according to an example aspect includes a program recorded on the computer-readable recording medium, the program including instructions that cause the computer to carry out:

a generation step of generating, based on first observation literals included in a first observation logical formula that represents an observation fact using a logical formula, a second observation logical formula including second observation literals expressing a numerical relationship of the first observation literals, and adding the second observation logical formula to the first observation logical formula: and

an abduction step of executing abduction by applying inference knowledge including a plurality of rules that are represented by logical formulas to the first observation logical formula and the second observation logical formula.

### ADVANTAGEOUS EFFECTS OF THE INVENTION

As one aspect, it is possible to reflect numerical relationships on abduction.

### BRIEF DESCRIPTION OF THE DRAWINGS

FIG. 1 is a diagram for describing weighted abduction and a numerical relationship.

FIG. 2 is a diagram for describing weighted abduction and a numerical relationship.

FIG. 3 is a diagram for describing an example of the inference apparatus.

FIG. 4 is a diagram for describing a result of abduction.

FIG. 5 is a diagram for describing a result of abduction.

FIG. 6 is a diagram for describing an example of a system including the inference apparatus.

FIG. 7 is a diagram for describing Example 1.

FIG. 8 is a diagram for describing Example 2.

FIG. 9 is a diagram illustrating an example of the operations of the inference apparatus.

FIG. 10 is a diagram for describing an example of a computer that realizes the inference apparatus.

### EXAMPLE EMBODIMENT

First, an outline will be described for facilitating understanding of the example embodiments described below.

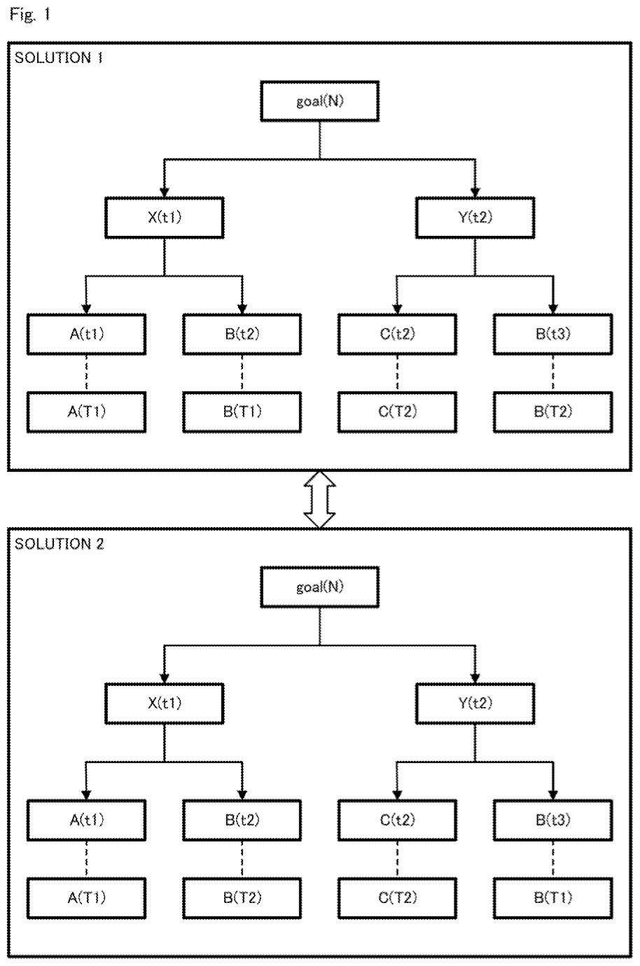

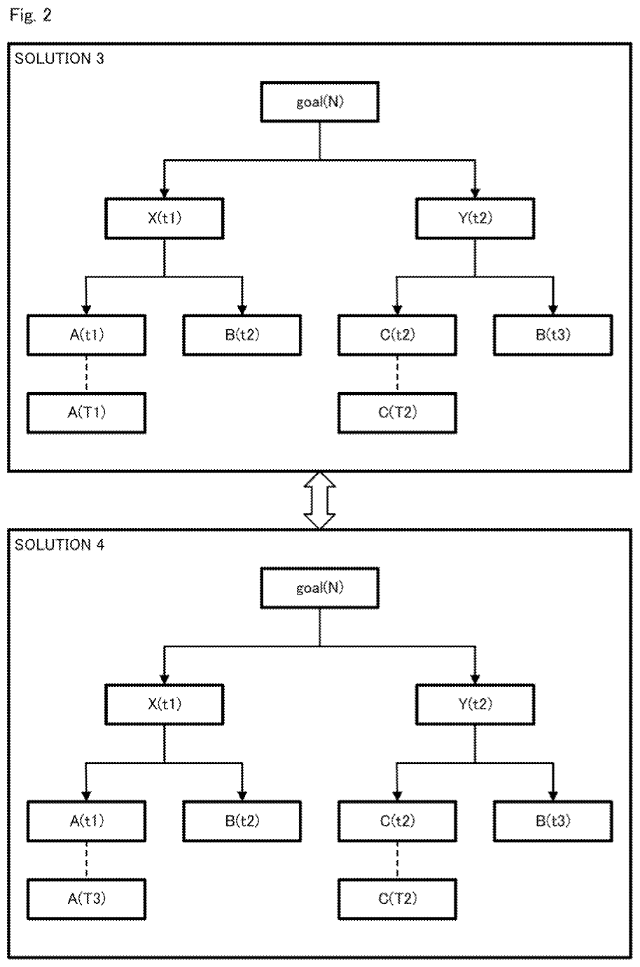

In the following example embodiments, cyber security is taken as an example, and the fact that a numerical relationship is difficult to be represented in weighted abduction will be described using FIGS. 1 and 2. FIGS. 1 and 2 are diagrams for describing weighted abduction and a numerical relationship.

Note that, in the example embodiments, a description will be given taking cyber security as an example, but the technique described in the example embodiments can also be applied to fields other than cyber security.

First, using FIG. 1, the fact will be described that, in weighted abduction, when a plurality of observation literals are unified, a combination of observation literals whose values of their terms are close cannot be preferentially selected.

The example in FIG. 1 shows a result of performing weighted abduction using rules (logical formula set) as shown in Formula 1 and an evidence (observed event: conjunction of first-order predicate logic literals) as shown in Formula 2. The literals are atomic formulas or atomic formulas with a negation symbol. When the atomic formula is p(t1, t2, etc.), for example, p is a predicate symbol and t1, t2, etc. are terms. Note that, in the following, a term of a literal is a variable when starting with an alphabetical small letter, and is a constant when starting with a capital letter. The result in FIG. 1 indicates that a solution 1 and a solution 2, which achieve a minimum cost, has been derived.

A(t1)^{0.0}\hat{ }B(t2)^{0.0}=>X(t1)

C(t2)^{0.0}\hat{ }B(t3)^{0.0}=>Y(t2)

X(t1)^{0.0}\hat{ }Y(t2)^{0.0}=>goal(n) Formula 1

X, Y: Attack mean

A, B, C: Evidence

t1, t2: Time

Goal: Query indicating that there was some kind of attack

Superscript of literal: Weight

A(T1)¹⁰⁰ \hat{ }B(T1)¹⁰⁰\hat{ }B(T2)¹⁰⁰ \hat{ }C(T2)¹⁰⁰ \hat{ }goal(N¹) Formula 2

T1, T2: Time

Superscript of literal: Cost

In the example in FIG. 1, first, hypothesis literals X(t1) and Y(t2) are derived from an observation literal Goal(N), which is a query indicating the start of deriving hypotheses by applying backward reasoning (arrows). Next, hypothesis literals A(t1) and B(t2) are derived from the hypothesis literal X(t1), and hypothesis literals C(t2) and B(t3) are derived from the hypothesis literal Y(t2). Note that, although not shown in FIG. 1, in backward reasoning, new hypotheses are derived using the rules and the observed event, and cost is propagated.

Next, in the example in FIG. 1, unification (broken lines) is performed. The solution 1 indicates that hypothesis literal A(t1) and the observation literal A(T1) are the same, the hypothesis literal B(t2) and the observation literal B(T1) are the same, the hypothesis literal C(t2) and the observation literal C(T2) are the same, and the hypothesis literal B(t3) and the observation literal B(T2) are the same. The solution 2 indicates that the hypothesis literal A(t1) and the observation literal A(T1) are the same, the hypothesis literal B(t2) and the observation literal B(T2) are the same, the hypothesis literal C(t2) and the observation literal C(T2) are the same, and the hypothesis literal B(t3) and the observation literal B(T1) are the same.

However, in the example in FIG. 1, the solution 1 and the solution 2 with which the cost is minimum are generated. The reason why the solution 1 and the solution 2 are generated is that, currently, evidences A, B, and C can only be regarded to be the same as one of evidences A, B, and C that are derived from an attack means X, or regarded to be the same as one of evidences A, B, and C that are derived from an attack means Y.

When the solution 1 and the solution 2 are compared, in the solution 1, the terms of the observation literal A(T1) and the observation literal B(T1) are both T1, and the terms of the observation literal C(T2) and the observation literal B(T2) are both T2, in contrast, in the solution 2, the terms of the observation literal A(T1) and the observation literal B(T2) are different, and the terms of the observation literal C(T2) and the observation literal B(T1) are also different. In such a case, a combination in which the times at which evidences have been observed are close is desired to be preferentially selected, that is, it is appropriate that the solution 1 in which the terms of the observation literals are the same is regarded as best.

Therefore, a method is conceivable for regarding the solution 1 as best using a logical formula. For example, rules as shown in Formula 3 are prepared. In Formula 3, A(t1) and B(t2) are requested as evidences of X(n), and furthermore a case where the values of the terms are the same (t1=t2) and a case where the values of the terms are different (t1!=t2) are also considered.

A(t1)\hat{ }B(t2)\hat{ }(t1=t2)=>X(n)

A(t1)\hat{ }B(t2)\hat{ }(t1!=t2)=>X(n) Formula 3

!: Negation

Also, weights are adjusted such that the evaluation by an evaluation function is improved when the rule in the first line in Formula 3 is used relative to when the rule in the second line in Formula 3 is used.

However, if the number of literals in antecedents of rules is increased, the number of rules explosively increases. For example, as a result of merely increasing the number of literals (A(t1), B(t2), and C(t3)) of antecedents to three, the number of rules is increased as shown in Formula 4, if sameness and difference of terms (t1, t2, t3) are considered.

A(t1)\hat{ }B(t2)\hat{ }C(t3)\hat{ }(t1=t2)\hat{ }(t2=t3)=>X(n)

A(t1)\hat{ }B(t2)\hat{ }C(t3)\hat{ }(t1!=t2)\hat{ }(t2=t3)=>X(n)

A(t1)\hat{ }B(t2)\hat{ }C(t3)\hat{ }(t1=t2)\hat{ }(t2!=t3)=>X(n)

A(t1)\hat{ }B(t2)\hat{ }C(t3)\hat{ }(t1=t3)\hat{ }(t2!=t3)=>X(n)

A(t1)\hat{ }B(t2)\hat{ }C(t3)\hat{ }(t1!=t2)\hat{ }(t2!=t3)\hat{ }(t3!=t1)=>X(n) Formula 4

Therefore, when the number of rules is increased, the search space for solution is expanded, and the inference calculation time increases. Also, when the number of rules is increased, the cost for maintaining the rules also increases.

Furthermore, as described above, when logical formulas are used, because logical formulas can only handle true or not, whether or not the terms are the same can only be handled. Therefore, a continuous numerical value indicating the closeness in time cannot be handled. As a result, when a plurality of observation literals are unified, a combination of observation literals in which the values of the terms thereof are close cannot be preferentially selected.

Next, the fact that attack means cannot be arranged in the order of first appearance with only using weighted abduction will be described using FIG. 2. In a cyber-attack, a plurality of attack means are used, and a same attack means is repeatedly executed, and therefore there is a need for understanding the degree of progress of the attack by arranging the attack means in the order of first appearance.

The example shown in FIG. 2 shows a result of performing weighted abduction, when attack means X and Y are executed in the order of X→Y→X, using rules as shown in Formula 1 and an evidence (observed event) as shown in Formula 5. In the example in FIG. 2, it is shown that a solution 3 and a solution 4, which achieve a minimum cost, are derived.

A(T1)¹⁰⁰\hat{ }B(T1)¹⁰⁰\hat{ }B(T2)¹⁰⁰\hat{ }C(T2)¹⁰⁰\hat{ }goal(N)1

T1<T2<T3 Formula 5

T1, T2, T3: Time

In the example in FIG. 2, first, backward reasoning (arrows) is applied, and hypothesis literals X(t1) and Y(t2) are derived from an observation literal Goal(N), which is a query. Next, the hypothesis literals A(t1) and B(t2) are derived from the hypothesis literal X(t1), and the hypothesis literals C(t2) and B(t3) are derived from the hypothesis literal Y(t2). Note that, although not shown in FIG. 2, in backward reasoning, new hypotheses are derived using the rules and the observed event, and cost is propagated.

Next, in the example in FIG. 2, a solution 3 and a solution 4 are obtained by performing unification (broken lines). The solution 3 indicates that the hypothesis literal A(t1) and the observation literal A(T1) are the same, and the hypothesis literal C(t2) and the observation literal C(T2) are the same. Also, the solution 4 indicates that the hypothesis literal A(t1) and the observation literal A(T3) are the same, and the hypothesis literal C(t2) and the observation literal C(T2) are the same.

However, the solution 3 and the solution 4 that achieve a minimum cost are generated. The reason why the solution 3 and the solution 4 are generated is because, in the example in FIG. 2, there are only a rule that the evidence A is observed at time t1 at which the attack means X has been executed, and a rule that the evidence C is observed at time t2 at which the attack means Y has been executed.

Moreover, it is because that the evidences A, B, and C, which are observed events, can only be regarded to be the same as one of evidences A, B, and C that are derived from the attack means X, or regarded to be the same as one of evidences A, B, and C that are derived from the attack means Y.

When the solution 3 and the solution 4 are compared, in the solution 3, the term of the observation literal A(T1) is T1 and the term of the observation literal C(T2) is T2, in contrast, in the solution 4, the term of the observation literal A(T3) is T3, and the term of the observation literal C(T2) is T2. In such a case, because the attack means X and Y are actually executed in the order of X→Y→X, it is appropriate that the solution 3 in which the attack means X and Y are arranged in the order of first appearance X→Y is regarded as best. Note that the solution 4 is not appropriate because the attack means X and Y are arranged in the order of Y→X.

Therefore, a method is conceivable for regarding the solution 3 as best using a logical formula. For example, a case where a sequence (time) of executing attack means is included in the rule is considered.

However, if the number of literals in antecedents of rules is increased, the number of rules explosively increases. For example, as a result of merely increasing the number of literals (A(t1), B(t2), C(t2), and B(t3)) of antecedents to four, if the sequence (temporal sequence) of t1, t2, and t3 is considered, the number of rules increases.

Also, if the temporal sequence is increased, the number of rules further increases. Therefore, when the number of rules is increased, the solution search space is expanded, and the inference calculation time increases. Also, when the number of rules is increased, the cost for maintaining the rules also increases.

Furthermore, as described above, when logical formulas are used, because logical formulas can only handle true or not, whether or not the terms are the same can only be handled. Therefore, the temporal sequence, which is a continuous numerical value, cannot be handled. As a result, when a plurality of observation literals are unified, the literals cannot be preferentially selected in the order of first appearance.

Through such a process, the inventor has found a problem that a numerical relationship cannot be reflected with only the weighted inference disclosed in Non-Patent Document 1 and the like. Also, the inventor has derived a means for solving the problem.

That is, the inventor has derived a means for, when a plurality of observation literals are unified, preferentially selecting a combination in which the values of the terms of observation literals are close, or a means for preferentially selecting a combination in which attack means are arranged in the order of first appearance. As a result, the numerical relationship can be reflected on abduction.

Hereinafter, the example embodiments will be described with reference to the drawings. Note that, in the drawings described below, the elements that have the same or corresponding functions are given the same reference numerals and description thereof may not be repeated.

### EXAMPLE EMBODIMENT

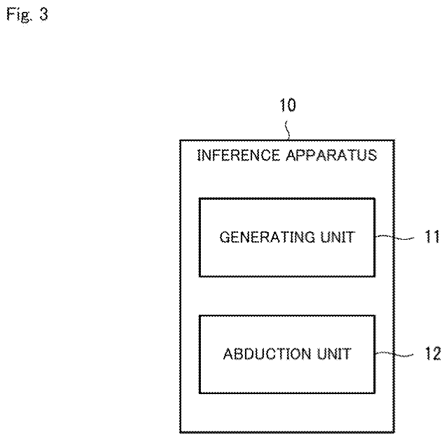

The configuration of an inference apparatus according to the example embodiment will be described using FIG. 3. FIG. 3 is a diagram for describing an example of the inference apparatus. The inference apparatus 10 shown in FIG. 3 includes a generating unit 11 and an abduction unit 12.

### Apparatus Configuration

The generating unit 11 generates, based on first observation literals included in a first observation logical formula in which an observed fact is represented by a logical formula, a second observation logical formula including second observation literals expressing a numerical relationship of the first observation literals, and adds the second observation logical formula to the first observation logical formula.

For example, based on the rule shown in Formula 6 and the observation logical formula (first observation logical formula) shown in Formula 7, in order to obtain an abduction result in which the closer the values of times t1, t2, and t3 are, the better the hypothesis is, a numerical relationship needs to be considered.

A(t1)\hat{ }B(t2)\hat{ }C(t3)=>goal(n) Formula 6

t1, t2, t3: Time

A(T11)\hat{ }B(T21)\hat{ }B(T22)\hat{ }C(T31)\hat{ } C(T32) \hat{ }C(T33)\hat{ }goal(N) Formula 7

T11, T21, T22, T31, T32, T33: Time

Therefore, first, a new literal (second literal) expressing a numerical relationship is manually or automatically added to the existing rule. When automatically generating the new literal, the generating unit 11 generates the new literal (second literal) expressing a numerical relationship based on the literals (first literals) included in the rule (first rule) shown in Formula 6 that is prepared in advance.

In this example, the closeness in values of times t1, t2, and t3 is focused on, and therefore the generating unit 11 generates close(t1,t2,t3) as a new literal, for example. Next, the generating unit 11 generates a new rule (second rule) shown in Formula 8 by adding the generated new literal close(t1,t2,t3) to the rule shown in Formula 6.

A(t1)\hat{ }B(t2)\hat{ }C(t3)\hat{ }close(t1,t2,t3)=>goal(n) Formula 8

close(t1,t2,t3): Literal about the closeness of the values of t1,t2,t3

Next, the generating unit 11 generates new observation literals (second observation literals) that correspond to the new literal (second literal) added to the rule (first rule) and express a numerical relationship. Specifically, the generating unit 11 generates, based on the observation literals (first observation literals) included in the observation logical formula (first observation logical formula) shown in Formula 7, observation literals (second observation literals) expressing the numerical relationship of the observation literals.

Next, the generating unit 11 generates a new observation logical formula (second observation logical formula) shown in Formula 9 using the observation literals (second observation literals) expressing a numerical relationship. Also, the generating unit 11 adds the new observation logical formula (second observation logical formula) shown in Formula 9 to the observation logical formula (first observation logical formula) shown in Formula 7.

As described above, in this example, the closeness in values of times t1, t2, and t3 is focused on, and therefore the generating unit 11 generates the observation logical formula (second observation logical formula) shown in Formula 9 by combining values of the terms of the observation literals A, B, and C.

close(T11,T21,T31)\hat{ }close(T11,T21,T32)\hat{ }. . . \hat{ }close(T11,T22,T33) Formula 9

Also, the generating unit 11 gives a cost to each new observation literal of the new observation logical formula. Specifically, costs are given to the observation literals close shown in Formula 9 such that the value of the cost increases as the values of terms t1, t2, and t3 are closer. For example, a cost R is calculated using a function as shown in Formula 10. Note that the method of calculating the cost is not limited to a method of using the function shown in Formula 10.

R=5*exp{−|T11−T21|−|T21−T31|−|T31−T11|} Formula 10

Note that the cost to be given to each new observation literal is a value such that the abduction result is consistent between before and after adding the new observation literals. Specifically, it is desirable that the cost to be given to each new observation literal takes a value such that the result obtained by removing the second observation literals from a result obtained by executing abduction in which the second observation literals are added to the first observation literals, is the same as one of a plurality of solution hypotheses having the same cost, in the result of executing abduction in which the second observation literals are not added.

The abduction unit 12 executes abduction by applying inference knowledge (new rule) including a plurality of rules represented by logical formulas to the generated new observation logical formula (second observation logical formula).

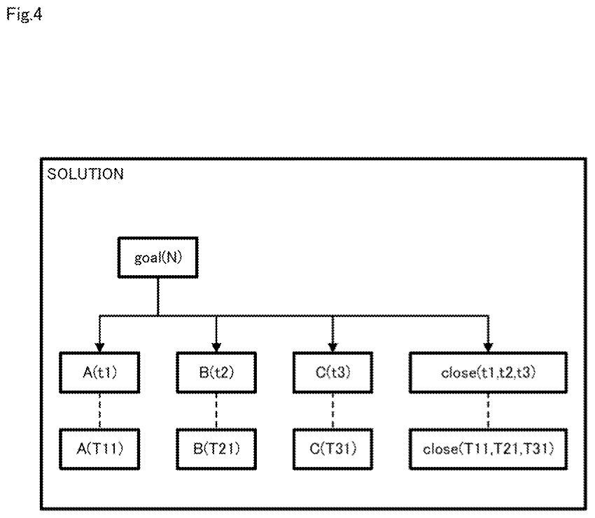

Specifically, the abduction unit 12 executes weighted abduction by applying the new rule shown in Formula 8 to an observation logical formula (second observation logical formula) obtained by adding the observation literals shown in Formula 9 to the existing observation literals shown in Formula 7. As a result, as shown in FIG. 4, for example, a result of executing weighted abduction (hypothesis candidate with minimum cost (solution hypothesis)) is obtained. FIG. 4 is a diagram for describing a result of abduction.

In the weighted abduction shown in FIG. 4, a hypothesis literal close(t1,t2,t3) and an observation literal close having a high cost (values of times t1, t2, and t3 are close) are unified, and as a result, a better hypothesis is easier to be obtained as the values of times t1, t2, and t3 are closer.

Note that when observation literals B(T21) and B(T22) have the same cost, and observation literals C(T31), C(T32), and C(T33) have the same cost, the reduction in cost obtained by unifying A(t1) with A(T11), B(t2) with B(T21), or C(t3) with C(T31) in FIG. 4 is the same as the reduction in cost obtained by unifying with the corresponding other observation literal (e.g., B(t2) with B(T22)).

Also, the degree of reduction in cost obtained by unifying the literal close added to the rule in FIG. 4 with one of the observation literals added to the observation logical formula changes according to the combination of values of the terms of the observation literals A, B, and C. Therefore, the numerical relationship is secured by the cost of the added observation literals.

Furthermore, the value of cost to be given when adding observation literals expressing a numerical relationship to an observation logical formula (cost of new observation literals to be added) needs to be a value, with which an inference result consistent with the inference result before giving the literals can be obtained. Therefore, the reduction in cost by unification of cost of one of the new observation literals is set to a relatively smaller value than the reduction in cost by unification of existing observation literals.

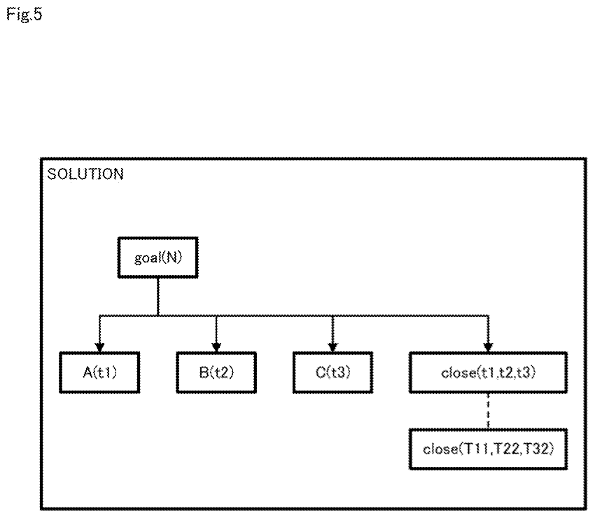

The reason for this is that, as shown in FIG. 5, if the reduction in cost by unification with one of added new observation literals is too large, even in a case of combination between terms t1, t2, and t3 with which logical contradiction arises in the unification between hypothesis literals A(t1), B(t2), and C(t3) and observation literals A, B, and C, a solution hypothesis is derived in which only the added observation literal close(T11,T22,T32) is unified. Such a solution hypothesis is not consistent with the result of abduction before adding the new observation literals, and is not a desired hypothesis. FIG. 5 is a diagram for describing a result of abduction.

As described above, according to the example embodiment, as a result of using the generating unit 11 and the abduction unit 12, a numerical relationship can be reflected on abduction.

### System Configuration

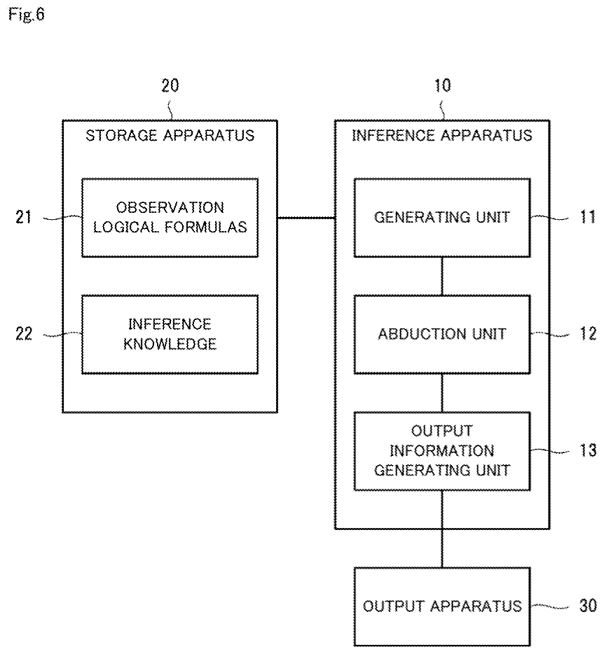

The configuration of the inference apparatus 10 in the example embodiment will be more specifically described using FIG. 6. FIG. 6 is a diagram for describing an example of a system including the inference apparatus.

As shown in FIG. 6, the system in the example embodiment includes the inference apparatus 10, a storage apparatus 20, and an output apparatus 30. The inference apparatus 10, the storage apparatus 20, and the output apparatus 30 are connected via a network.

The inference apparatus 10 includes the generating unit 11, the abduction unit 12, and an output information generating unit 13. The inference apparatus 10 is an information processing apparatus such as a server computer or a personal computer on which a programmable device such as a CPU (Central Processing Unit) or an FPGA (Field-Programmable Gate Array) or both of the programmable devices are mounted, for example. Note that the details of the inference apparatus 10 will be described later.

The storage apparatus 20 includes observation logical formulas 21 and inference knowledge 22. The storage apparatus 20 is a database or a storage, a server computer, or the like. The observation logical formulas 21 are obtained by representing observed facts by logical formulas (conjunctions of first-order predicate logic literals). The inference knowledge 22 includes a plurality of rules (logical formula set) represented by logical formulas.

The storage apparatus 20 is provided outside the inference apparatus 10 in the example in FIG. 6, but may be provided inside the inference apparatus 10. Also, one storage apparatus 20 is shown in the example in FIG. 6, but the storage apparatus 20 may also be constituted by a plurality of storage apparatuses. In this case, the observation logical formulas 21 and the inference knowledge 22 may also be stored in a distributed manner.

The output apparatus 30 acquires later-described output information that is converted, by the output information generating unit 13, into a format that can be output, and outputs images, audio and the like generated based on this output information. The output apparatus 30 is an image display apparatus that uses liquid crystal, organic EL (ElectroLuminescence) or a CRT (Cathode Ray Tube). Furthermore, the image display apparatus may include an audio output apparatus such as a speaker, and the like. Note that the output apparatus 30 may also be a printing device such as a printer.

The inference apparatus will be described.

Specifically, the generating unit 11 generates an observation logical formula (second observation logical formula) including new observation literals (second observation literals) expressing a numerical relationship, and adds the second observation logical formula to existing observation logical formulas 21 (set) stored in the storage apparatus 20.

Note that one or more new literals (second literal) expressing a numerical relationship are manually or automatically added to the rules of the inference knowledge 22 stored in the storage apparatus 20.

The abduction unit 12 applies inference knowledge including one or more new rules to the generated new observation logical formula, and executes abduction.

The output information generating unit 13 generates output information for causing the output apparatus 30 to output rules, observation literals, abduction results, and the like, and outputs the output information to the output apparatus 30.

### EXAMPLE 1

In Example 1, with respect to evidences A and B related to an attack means X and evidences C and B related to an attack means Y, hypotheses in which times of evidences, in each pair, are close are obtained. Note that, in Example 1, a case where a new rule is automatically generated will be described.

In Example 1, the generating unit 11 first generates new literals (second literals) expressing a numerical relationship that are to be added to the rules shown in Formula 11.

A(t1)^{0.0}\hat{ }B(t2)^{0.0}=>X(t1)

C(t2)^{0.0}\hat{ }B(t3)^{0.0}=>Y(t2)

X(t1)^{0.0}\hat{ }Y(t2)^{0.0}=>goal(n) Formula 11

Next, the generating unit 11 adds the new literals to the rules in Formula 11, as shown in Formula 12. In Example 1, a literal closeAB(t1,t2) expressing closeness in time between literals A and B and a literal closeCB(t2,t3) expressing closeness in time between literals C and B are generated.

A(t1)^{0.0}\hat{ }B(t2)^{0.0}\hat{ }closeAB(t1,t2)^{0.0}=>X(t1)

C(t2)^{0.0}\hat{ }B(t3)^{0.0}\hat{ }closeCB(t2,t3)^{0.0}=>Y(t2)

X(t1)^{0.0}\hat{ }Y(t2)^{0.0}=>goal(n) Formula 12

Note that one or more new literals expressing a numerical relationship may be manually generated. Also, the generated one or more new literals may be manually added to the rule.

Next, the generating unit 11 generates a new observation logical formula, shown in Formula 14, that includes new observation literals close that express a numerical relationship, and correspond to the new literals added to the rules shown in Formula 12, in order for the new observation logical formula to be added to the observation logical formula shown in Formula 13. Also, the generating unit 11 adds the new observation logical formula shown in Formula 14 to the observation logical formula shown in Formula 13.

A(T1)¹⁰⁰\hat{ }B(T1)¹⁰⁰\hat{ }B(T2)¹⁰⁰\hat{ }C(T2)¹⁰⁰\hat{ }C(T3)¹⁰⁰\hat{ }goal(N)¹

T1<T2<T3 Formula 13

closeAB(T1,T1)^{5*exp {-|T1-T1|}\hat{ }closeAB(T}1,T2)^{5*exp {-|T1-T2|}}

\hat{ }closeCB(T2,T1)^{5*exp {-|T2-T1|}\hat{ }closeCB(T}2,T2)^{5*exp {-|T2-T2|}}

\hat{ }closeCB(T3,T1)^{5*exp {-|T3-T1|}\hat{ }closeCB(T}3,T2)^{5*exp {-|T3-T2|}} Formula 14

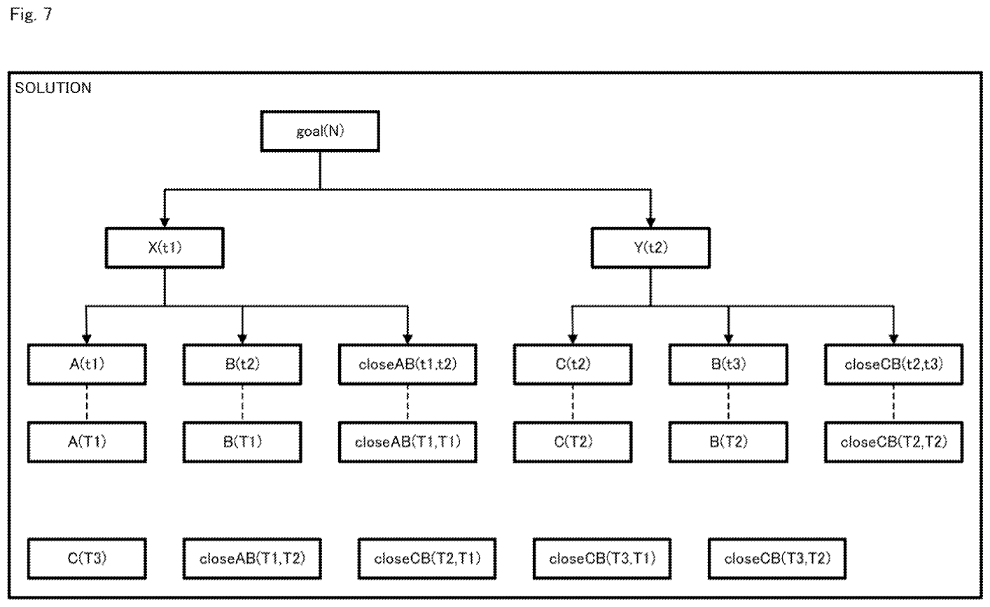

Note that the costs to be given to closeAB and closeCB, which are added observation literals, take values such that, if the added observation literals are removed from the solution hypothesis shown in FIG. 7, one of the abduction results before adding the new observation literals appears.

Next, the abduction unit 12 applies the inference knowledge including the rules shown in Formula 12 to the observation logical formulas shown in Formula 13 and Formula 14, and executes abduction. As a result, the solution hypothesis shown in FIG. 7 can be obtained. FIG. 7 is a diagram for describing Example 1.

In the example in FIG. 7, in combinations between hypothesis literals A and B (portion related to X) and hypothesis literals C and B (portion related to Y), the cost becomes minimum as a result of observation literals closeAB and closeCB whose costs are highest being unified. That is, a combination in which times are close is obtained.

### Example 2

In Example 2, a hypothesis in which attack means X and Y are in the order of first appearance is obtained. Note that, in Example 2, a case where a new rule is automatically generated will be described.

In Example 2, the generating unit 11, first, generates new literals (second literals) expressing a numerical relationship to be added to the rules shown in Formula 15.

A(t1)^{0.0}\hat{ }B(t2)^{0,0}=>X(t1)

C(t2)^{0.0}\hat{ }B(t3)^{0,0}=>Y(t2)

X(t1)^{0.0}\hat{ }Y(t2)^{0.0}=>goal(n) Formula 15

Next, the generating unit 11 adds the new literals to the rules shown in Formula 15, as shown in Formula 16. In Example 2, the generating unit 11 generates literals early(t1) and early(t2) that indicate earliness in time.

A(t1)^{0.0}\hat{ }B(t2)^{0.0}\hat{ }early(t1)^{0.0}=>X(t1)

C(t2)^{0.0}\hat{ }B(t3)^{0.0}\hat{ }early(t2)^{0.0}=>Y(t2)

X(t1)^{0.0}\hat{ }Y(2)^{0.0}=>goal(n) Formula 16

Note that one or more new literals expressing a numerical relationship may also be manually generated. Also, the generated one or more new literals may also be manually added.

Next, the generating unit 11 generates new observation literals, shown in Formula 18, that express a numerical relationship, and correspond to the new literals added to the rules shown in Formula 16, in order for the new observation literals to be added to the existing observation logical formula shown in Formula 17. Also, the generating unit 11 adds the new observation logical formula shown in Formula 18 to the observation logical formula shown in Formula 17.

A(T1)¹⁰⁰\hat{ }A(T3)¹⁰⁰\hat{ }C(T2)¹⁰⁰\hat{ }C(T4)¹⁰⁰\hat{ }goal(N)¹

T1<T2<T3<T4 Formula 17

early(T1)^{(T4-T1)/(T4-T1)}

\hat{ }early(T2)^{(T4-T2)/(T4-T1)}

\hat{ }early(T3)^{(T4-T3)/(T4-T1)}

\hat{ }early(T4)^{(T4-T4)/(T4-T1)} Formula 18

Note that, in this example, the cost of the observation literal early(t) is set to (T4−t)/(T4−T1) using a largest time T4 and a smallest time T1, among times that appear.

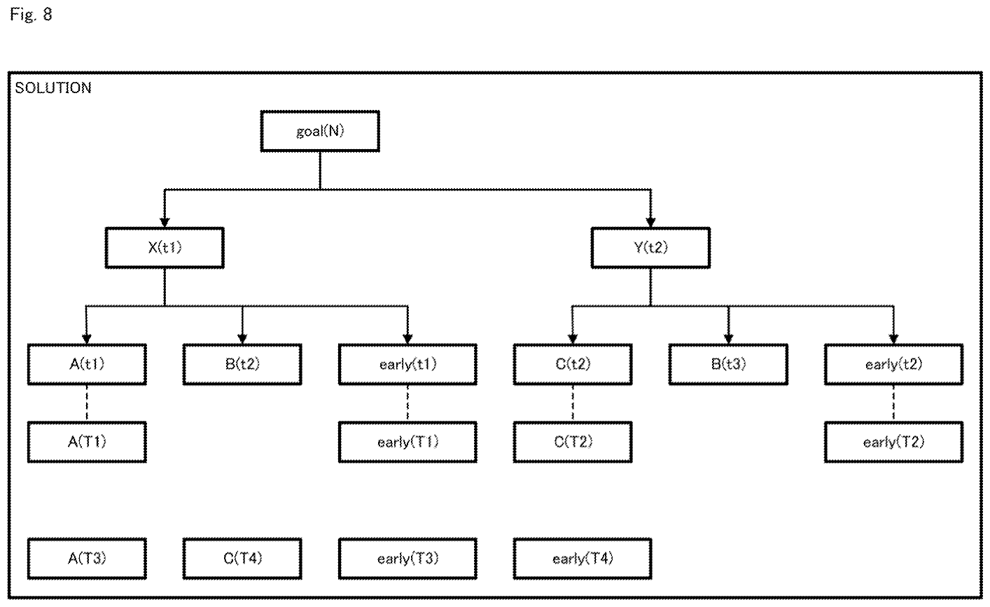

Next, the abduction unit 12 applies inference knowledge including the rules shown in Formula 16 to the observation logical formulas shown in Formula 17 and Formula 18, and executes abduction. As a result, a solution hypothesis shown in FIG. 8 can be obtained. FIG. 8 is a diagram for describing Example 2. As shown in FIG. 8, as a result of observation literals early having a high cost being unified, the cost becomes minimum. That is, the order of first appearance is achieved.

### Apparatus Operations

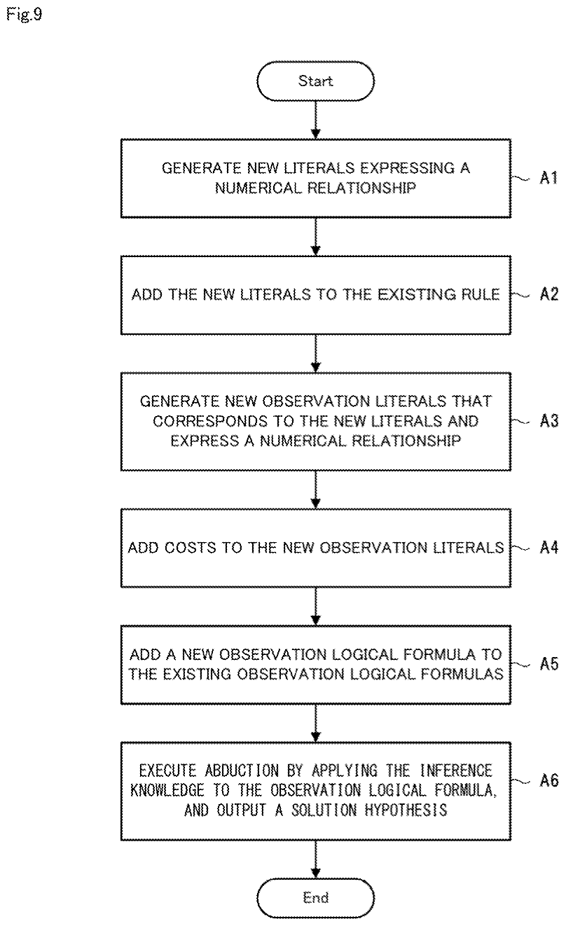

Next, operations of the inference apparatus in the example embodiment will be described using FIG. 9. FIG. 9 is a diagram illustrating an example of the operations of the inference apparatus. In the following description, the drawings will be referred to as appropriate. Furthermore, in the example embodiment, an inference method is implemented by causing the inference apparatus to operate. Accordingly, the following description of the operations of the inference apparatus is substituted for the description of the inference method in the example embodiment.

A case where a rule is automatically generated will be described in FIG. 9. First, the generating unit 11 generates new one or more literals expressing a numerical relationship (step A1). Specifically, in step A1, the generating unit 11 generates one or more new literals (second literals) expressing a numerical relationship based on literals (first literals) included in a rule (first rule) that is prepared in advance.

Next, the generating unit 11 adds the one or more new literals to the existing one or more rules (step A2). Specifically, in step A2, the generating unit 11 generates one or more new rules (second rules) by adding the one or more new literals (second literals) generated in step A1 to one or more rules (first rules) that are prepared in advance.

Next, the generating unit 11 generates new observation literals that corresponds to the one or more new literals and express a numerical relationship (step A3). Specifically, in step A3, the generating unit 11 generates, based on the observation literals (first observation literals) included in the observation logical formula (first observation logical formula), observation literals (second observation literals) expressing a numerical relationship of the first observation literals.

Next, the generating unit 11 adds costs to the new observation literals (step A4). Specifically, in step A4, the generating unit 11 calculates the costs of the new observation literals using a function determined in advance, or the like.

Next, the generating unit 11 adds a new observation logical formula including the new observation literals to the existing observation logical formulas (set) (step A5). Specifically, in step A5, the generating unit 11 generates a new observation logical formula (second observation logical formula) using observation literals (second observation literals) that express a numerical relationship. Then, the generating unit 11 adds the new observation logical formula (second observation logical formula) to the observation logical formulas (first observation logical formulas).

Next, the abduction unit 12 executes abduction by applying the inference knowledge to the observation logical formula, and outputs a solution hypothesis (step A6). Specifically, in step A6, the abduction unit 12 applies the new rule (second rule) to the existing observation logical formula (first observation logical formula) and the new observation logical formula (second observation logical formula), and executes weighted abduction. As a result, a hypothesis candidate (solution hypothesis) having a minimum cost on which the numerical relationship is reflected is obtained as the result of weighted abduction.

### Effects of Embodiment

As described above, according to the example embodiment, an abduction result on which a numerical relationship is reflected can be obtained.

Also, although the rule is changed, the number of rules is not increased, as in the case of known techniques, and therefore the solution search space is not expanded, and the inference calculation time can be suppressed relative to the known case in which the number of rules is increased.

Also, the numerical relationship is secured by the cost of an added observation literal, and abduction is performed in a state in which the added observation literal is included, and therefore the logical consistency and the numerical relationship can be established at the same time.

### Program

The program according to an embodiment may be a program that causes a computer to execute steps A1 to A6 shown in FIG. 9. By installing this program in a computer and executing the program, the inference apparatus and the inference method according to the example embodiment can be realized. In this case, the processor of the computer performs processing to function as the generating unit 11, the abduction unit 12, and the output information generating unit 13.

Also, the program according to the embodiment may be executed by a computer system constructed by a plurality of computers. In this case, for example, each computer may function as any of the generating unit 11, the abduction unit 12, and the output information generating unit 13.

### Physical Configuration

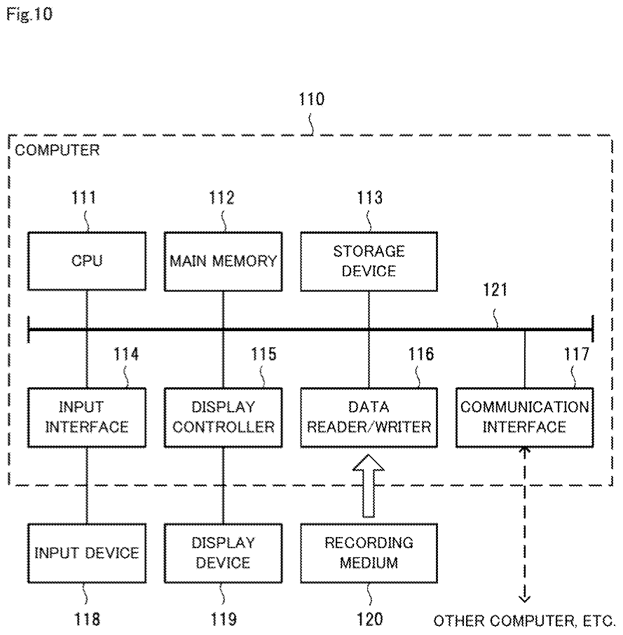

Here, a computer that realizes an inference apparatus by executing the program according to an example embodiment will be described with reference to FIG. 10. FIG. 10 is a diagram for describing an example of a computer that realizes the inference apparatus.

As shown in FIG. 10, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the event analysis support apparatus 1 according to this example embodiment can also be realized by using hardware corresponding to each unit. Furthermore, a portion of the event analysis support apparatus 1 may be realized by a program, and the remaining portion realized by hardware.

### Supplementary Notes

Furthermore, the following supplementary notes are disclosed regarding the example embodiments described above. Some portion or all of the example embodiments described above can be realized according to (supplementary note 1) to (supplementary note 9) described below, but the below description does not limit the invention.

### Supplementary Note 1

An inference apparatus comprising:

a generation unit that generates, based on first observation literals included in a first observation logical formula that represents an observation fact using a logical formula, a second observation logical formula including second observation literals expressing a numerical relationship of the first observation literals, and adding the second observation logical formula to the first observation logical formula: and

an abduction unit that executes abduction by applying inference knowledge including a plurality of rules that are represented by logical formulas to the first observation logical formula and the second observation logical formula.

### Supplementary Note 2

The inference apparatus according to Supplementary Note 1,
wherein the rules are logical formulas in which one or more second literals that expresses a numerical relationship and are generated based on first literals included in one or more first rules that are prepared in advance are added to the one or more first rules.

### Supplementary Note 3

The inference apparatus according to Supplementary Note 1 or 2,

wherein the cost of the second observation literals takes a value such that a result obtained by removing the second observation literals, from a result obtained by executing abduction in which the second observation literals is added to the first observation literals, is the same as one of a plurality of solution hypotheses having the same cost, in a result of executing abduction in which the second observation literals is not added.

### Supplementary Note 4

An inference method comprising:

a generation step of generating, based on first observation literals included in a first observation logical formula that represents an observation fact using a logical formula, a second observation logical formula including second observation literals expressing a numerical relationship of the first observation literals, and adding the second observation logical formula to the first observation logical formula: and

an abduction step of executing abduction by applying inference knowledge including a plurality of rules that are represented by logical formulas to the first observation logical formula and the second observation logical formula.

### Supplementary Note 5

The inference method according to Supplementary Note 4,

wherein the rules are logical formulas in which one or more second literals that expresses a numerical relationship and are generated based on first literals included in one or more first rules that are prepared in advance is added to the one or more first rules.

### Supplementary Note 6

The inference method according to Supplementary Note 4 or 5,

wherein the cost of the second observation literals takes a value such that a result obtained by removing the second observation literals, from a result obtained by executing abduction in which the second observation literals is added to the first observation literals, is the same as one of a plurality of solution hypotheses having the same cost, in a result of executing abduction in which the second observation literals is not added.

### Supplementary Note 7

A computer-readable recording medium that includes a program including instructions recorded thereon, the instructions causing a computer to carry out:

a generation step of generating, based on first observation literals included in a first observation logical formula that represents an observation fact using a logical formula, a second observation logical formula including second observation literals expressing a numerical relationship of the first observation literals, and adding the second observation logical formula to the first observation logical formula: and

an abduction step of executing abduction by applying inference knowledge including a plurality of rules that are represented by logical formulas to the first observation logical formula and the second observation logical formula.

### Supplementary Note 8

The computer-readable recording medium according to Supplementary Note 7,

wherein the rules are logical formulas in which one or more second literal that expresses a numerical relationship and are generated based on first literals included in one or more first rule that are prepared in advance are added to the one or more first rule.

### Supplementary Note 9

The computer-readable recording medium according to Supplementary Note 7 or 8,

wherein the cost of the second observation literals takes a value such that a result obtained by removing the second observation literals, from a result obtained by executing abduction in which the second observation literals is added to the first observation literals, is the same as one of a plurality of solution hypotheses having the same cost, in a result of executing abduction in which the second observation literals is not added.

Although the invention of this application has been described with reference to exemplary embodiments, the invention of this application is not limited to the above exemplary embodiments. Within the scope of the invention of this application, various changes that can be understood by those skilled in the art can be made to the configuration and details of the invention of this application.

### INDUSTRIAL APPLICABILITY

As described above, according to the invention, it is possible to reflect numerical relationships on abduction. The invention is useful in fields where it is necessary to abduction.

### REFERENCE SIGNS LIST

10 Inference apparatus
11 Generating unit
12 Abduction unit
13 Output information generating unit
20 Storage apparatus
21 Observation logical formula
22 Inference knowledge
30 Output apparatus
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An inference apparatus comprising:
one or more memories storing instructions; and
one or more processors configured to execute the instructions to:
generate, based on first observation literals included in a first observation logical formula that represents an observation fact using a logical formula, a second observation logical formula including second observation literals expressing a numerical relationship of the first observation literals, and add the second observation logical formula to the first observation logical formula: and
execute abduction by applying inference knowledge including a plurality of rules that are represented by logical formulas to the first observation logical formula and the second observation logical formula.

2. The inference apparatus according to claim 1,
wherein the rules are logical formulas in which one or more second literals that expresses a numerical relationship and are generated based on first literals included in one or more first rules that are prepared in advance is added to the one or more first rule.

3. The inference apparatus according to claim 1,
wherein the cost of the second observation literals takes a value such that a result obtained by removing the second observation literals, from a result obtained by executing abduction in which the second observation literals is added to the first observation literals, is the same as one of a plurality of solution hypotheses having the same cost, in a result of executing abduction in which the second observation literals is not added.

4. An inference method comprising:
generating, based on first observation literals included in a first observation logical formula that represents an observation fact using a logical formula, a second observation logical formula including second observation literals expressing a numerical relationship of the first observation literals, and adding the second observation logical formula to the first observation logical formula: and
executing abduction by applying inference knowledge including a plurality of rules that are represented by logical formulas to the first observation logical formula and the second observation logical formula.

5. The inference method according to claim 4,
wherein the rules are logical formulas in which one or more second literals that expresses a numerical relationship and are generated based on first literals included in one or more first rules that are prepared in advance is added to the one or more first rule.

6. The inference method according to claim 4,
wherein the cost of the second observation literals takes a value such that a result obtained by removing the second observation literals, from a result obtained by executing abduction in which the second observation literals is added to the first observation literals, is the same as one of a plurality of solution hypotheses having the same cost, in a result of executing abduction in which the second observation literals is not added.

7. A non-transitory computer-readable recording medium that includes a program including instructions recorded thereon, the instructions causing a computer to carry out:
generating, based on first observation literals included in a first observation logical formula that represents an observation fact using a logical formula, a second observation logical formula including second observation literals expressing a numerical relationship of the first observation literals, and adding the second observation logical formula to the first observation logical formula: and
executing abduction by applying inference knowledge including a plurality of rules that are represented by logical formulas to the first observation logical formula and the second observation logical formula.

8. The non-transitory computer-readable recording medium according to claim 7,
wherein the rules are logical formulas in which one or more second literals that expresses a numerical relationship and are generated based on first literals included in one or more first rule that are prepared in advance is added to the one or more first rule.

9. The non-transitory computer-readable recording medium according to claim 7,
wherein the cost of the second observation literals takes a value such that a result obtained by removing the second observation literals, from a result obtained by executing abduction in which the second observation literals is added to the first observation literals, is the same as one of a plurality of solution hypotheses having the same cost, in a result of executing abduction in which the second observation literals is not added.
